(19) United States
(12) Patent Application Publication
(10) Pub. No.: US 2023/0363409 A1
(43) Pub. Date: Nov. 16, 2023

(54) PEA PROTEIN WITH IMPROVED PROCESSING CHARACTERISTICS FOR LOW MOISTURE EXTRUSION

(71) Applicant: Nowadays Inc., PBC, San Francisco, CA (US)

(72) Inventors: Dominik Grabinski, San Francisco, CA (US); William Aimutis, San Francisco, CA (US)

(21) Appl. No.: 18/317,875

(22) Filed: May 15, 2023

Related U.S. Application Data
(60) Provisional application No. 63/341,819, filed on May 13, 2022.

(51) Int. Cl. A23J 3/14

(52) U.S. Cl. CPC A23J 3/14

(57) ABSTRACT

The criteria for pea protein with improved processibility by low moisture extrusion and consistency of protein have been experimentally determined. These criteria include a water holding capability above 35% in combination with water binding capability above 2.5 g of water g of sample), a protein and water interaction occurring at ambient temperature that forms a viscous solution as the proteins hydrate with an apparent viscosity in centipoise (cP) ranging from 400 to 500, upon heating of the protein dough plasticization occurs from an interaction of water and selected proteins to yield a melted/denatured complex having an apparent viscosity of 250 to 500 cP, and a low potassium (below 0.2 % by weight) content and high sodium content (above 0.8% by weight).

### CROSS-REFERENCE TO RELATED APPLICATIONS

This application claims the benefit of and priority to U.S. Provisional Application No. 63/341,819 filed May 13, 2022, which is hereby incorporated by reference in its entirety.

### FIELD OF THE INVENTION

This invention is generally in the field of plant materials for low moisture extrusion into plant-based meat substitutes.

### BACKGROUND OF THE INVENTION

One of the most popular new foods are plant-based products. These are rapidly increasing market share at a rate five times that of total food sales. This is most evident in the way meatless burgers have found their way out of the health food aisle and onto restaurant menus. While plant-based protein manufacturing companies are eager to give consumers what they want, they are also challenged to produce large-scale offerings.

Most plant-based meat substitutes contain multiple ingredients to imitate the complex texture, flavor and appearance of meat. These mixtures are then extruded to form meat patties, nuggets, sticks, optionally mixed with a sauce or breaded, packaged and frozen for distribution.

Extrusion mixes and cooks the ingredients rapidly. The process is complex, requiring expensive equipment with many possible calibrations. Extrusion uses moisture, high heat and mechanical energy to produce meat substitutes in a matter of seconds.

The first step in extrusion is mixing and pre-conditioning protein powders. This typically involves proteins made from pulses such as soy, lentils or chickpeas with water, steam and/or oil. This pre-mixing brings the ingredients into contact with each other before they are discharged into the extruder, where further mixing occurs. It can be used to begin hydrating protein powders, to ensure a more uniform product, or to pre-heat the powder blend. The ingredient mixture is fed into a twin-screw extruder, essentially a metal barrel where it is sheared and mixed by two rotating screws while being heated via a steam jacket surrounding the cylinder. The screws push the mixture along the barrel, compressing and mixing it as it moves toward a die at the end of the cylinder. The proteins in the mixture are denatured by the heat provided by the steam, and by the mechanical energy generated by the screws in the cylinder and friction. The semi-solid product may be extruded through a thermoregulated die, giving the operator control to cool or puff the product, to create the desired muscle fiber-like texture. It may also be cut as it exits the die.

The extruded product undergoes further processing that is similar to the meat industry—cutting, grinding, shredding, marinating, coating and/or further cooking. Heat pasteurization, UV irradiation or the use of preservatives can be used to extend the shelf life or enhance the food safety of the final product.

Extrusion is much more complex than typical food processing. The application of thermal and mechanical energy is unique to extrusion. The combination of thermal energy, mechanical energy and mixing is affected by the specifics of the extrusion equipment, such as die design, screw speed, back pressure, dwell time and formulation. Thermal energy is used during pre-conditioning to raise the temperature of the mixture before it enters the extruder. It is further applied to heat the product as it passes through the cylinder. Heat transfer becomes more difficult at larger scales since the surface area to volume ratio is reduced. Though commercial extruders maximize the heat transfer area, the circumference of the twin screws, that can still be heated by high-pressure steam, they have reduced heat transfer compared to the amount of material to be heated. The mechanical energy of the rotating screws and the compression of the mixture being forced toward the die is unique in food production. Typically, increased pressure within the cylinder is indicative of more mechanical energy being generated.

One of the major factors in consistent results in extrusion is the plant material being fed into the extruder. Variation between lots can have dramatic effects on the extruded product, resulting in product that does not meet the required specifications. One of the reasons soy is commonly used is that it is easily to process, and there is less variation between lots. However, many people are allergic to soy.

It is therefore an object of the present invention to provide the criteria for pea protein that has increased consistency and product characteristics when extrusion processed under low moisture conditions.

### SUMMARY OF THE INVENTION

The criteria for pea protein with improved processibility by low moisture extrusion and consistency of protein have been experimentally determined. These criteria include a water holding capability above 35% in combination with water binding capability above 2.5 g of water g of sample), a protein and water interaction occurring at ambient temperature that forms a viscous solution as the proteins hydrate with an apparent viscosity in centipoise (cP) ranging from 400 to 500, upon heating of the protein dough plasticization occurs from an interaction of water and selected proteins to yield a melted/denatured complex having an apparent viscosity of 250 to 500 cP, and a low potassium (below 0.2 % by weight) content and high sodium content (above 0.8% by weight) .

### DETAILED DESCRIPTION OF THE INVENTION

### I. Definitions

An alkali solution is a solution of a soluble base has a pH greater than 7.0.

Hydrophilic polymers are those polymers which dissolve in, or are swollen by, water, including many polymers of natural origin. Many foodstuffs, containing substantial amounts of carbohydrate and protein, can be classified as hydrophilic polymers. More than two-thirds of hydrophilic or water-soluble polymers used in industry are derived from polymers of natural origin.

A meat substitute or meat analogue, approximates certain aesthetic qualities (primarily texture, flavor and appearance) or chemical characteristics of a specific meat. Substitutes are often based on soybeans, gluten, peas, or legumes.

A legume is a plant in the family Fabaceae (or Leguminosae), or the fruit or seed of such a plant. When used as a dry grain, the seed is called a pulse. Legumes include alfalfa, clover, beans, peas, chickpeas, lentils, lupins, mesquite, carob, soybeans, peanuts, and tamarind.

### II. Pea Proteins

The protein source is a Pea protein isolate, either unmodified or modified. Pea proteins produced based on dry-milling and wet-milling technologies will have a protein content between about 48% to 90%. Nutritional benefits, water-binding capacity, oil-binding capacity, foam expansion, foam stability, whippability, gelation, emulsion stability and emulsion ability ratio are major functional properties of pea protein concentrates and isolates.

Pea protein has unique properties compared to soybean protein isolates. Most chemically modify the pea protein to impart more favorable processing characteristics for use comparably to soy See, for example, Kaur et al. Comparative study of the functional, thermal and pasting properties of flours from different field pea (Pisum sativum L.) and pigeon pea (Cajanus cajan L.) cultivars, Food Chemistry, 104(1):259-267 (2007), ISSN 0308-8146, doi.org/10.1016/j.foodchem.2006.11.037; O’Kane, et al. Gelation behavior of protein isolates extracted from 5 cultivars of pisum sativum L. J Food Sci. 70(2):C132-C137 (2005); Periago,et al. Influence of enzymatic treatment on the nutritional and functional properties of pea flour, Food Chemistry, 63:71-78 (1998), ISSN 0308-8146, doi.org/10.1016/S0308-8146(97)00199-4; Rangel, et al, J. Agricul. Food Chem. 51(19): 5792-5797 (2003) DOI: 10.1021/jf0340052; Shand, Phyllis & Ya, Hubb & Pietrasik, Zeb & Wanasundara, P.. (2007). Physicochemical and textural properties of heat-induced pea protein isolate gels. Food Chemistry. 102:1119-1130. 10.1016/j.foodchem.2006.06.060; Shand, et al. Transglutaminase treatment of pea proteins: Effect on physicochemical and rheological properties of heat-induced protein gels. Food Chemistry. 107:692-699 (2008). 10.1016/j.foodchem.2007.08.095;

In terms of functionality, gels made from pea protein isolates are weaker than soybean protein isolates (Bildstein, et al. An enzyme-based extraction process for the purification and enrichment of vegetable proteins to be applied in bakery products. European Food Research and Technology = Zeitschrift für Lebensmittel-Untersuchung und -Forschung.A. 228(2):177-186 (2008). Pea proteins are a better emulsifier and foaming agent at pH 7.0 compared to soy protein isolates. The functional properties of pea proteins can be improved by applying enzymatic treatments (Shand et al., 2008; Sun & Arntfield, Gelation properties of salt-extracted pea protein isolate catalyzed by microbial transglutaminase cross-linking, Food Hydrocolloids, 25(1):25-31 (2011), ISSN 0268-005X, doi.org/10.1016/j.foodhyd.2010.05.002), while acid proteases increased its emulsification capacity (Periago et al., 1998). These enzymatic treatments help transform pea protein isolates into functional proteins comparable to egg-white proteins and soy protein isolates. Since most of the carbohydrates are removed in manufacturing pea protein isolates, the RVA profile is much flatter compared to pea protein concentrates, even though both products have similar final viscosity values. Accordingly, it is preferable to use unmodified pea protein.

There are a number of commercial sources of pea protein powder.

PURIS^{®} protein (Cargill) is preferred. PURIS^{®} pea protein is produced from U.S. yellow pea seed varieties, selected to minimize the off-flavors normally attributed to pulses. It has a minimum 80% protein content, it is not genetically modified (“Non-GMO”), certified organic, vegan, gluten-free and soy-free.

Others include:
Roquettefound for NUTRALYS®
Unilever CHEMPOINT
PRINOVA
A&B Ingredients

It has now been determined that selection of the pea protein having certain characteristics is critical to having desirable extrusion properties. These criteria include a water holding capability above 35% by weight in combination with water binding capability above 2.5 g of water g of pea protein), a viscosity in water at room temperature (25° C.) in cP between about 400 and 500 cP non-heated and a low potassium content and high sodium content (i.e., a potassium content below 0.2 % by weight, and a sodium content above 0.8% by weight), both driving a low buffer capacity.

Viscosity development refers to a protein and water interaction occurring at ambient temperature, and a low potassium and sodium concentration that forms a viscous solution as the proteins hydrate with an apparent viscosity in cP ranging from 400 to 500 at room temperature (25°), and, upon heating, a protein plasticization occurs from an interaction of water and selected proteins to yield a melted/denatured complex having an apparent viscosity of 250 to 500 cP.

Dubina et al. Potassium ions are more effective than sodium ions in salt induced peptide formation. Orig. Life Evol Biosph. 43:109-117 (2013), demonstrated that potassium ions are more effective at inducing protein interactions than sodium ions. The result of this interaction in extruding proteins is that polar amino acids that are needed for hydration and elongation of the protein could be buried in the macromolecular structure, thereby reducing the desired texturization properties. Vrbka et al. Proc Natl Acad Sci U S A 103(42): 15440-15444 (2006) doi:10.1073/pnas.0606959103 showed proteins have a higher affinity to sodium than potassium. In terms of protein solvation, for water to interact with protein molecules, a protein manufactured with higher sodium content will bind more strongly to protein surfaces than potassium. In terms of extrusion, this reflects the ability of proteins to more adequately align and form desirable textural properties. A protein manufactured with higher potassium levels will be denser in texture due to the ion being a weak chaotrope (water structure breaking). In summary, sodium enhances polymerization of the protein complexes more readily than potassium.

### Hydrophilic Polymers

Hydrophilic polymers are used to increase moisture content and improve texture. Between 3 and 10% weight/weight of the hydrophilic polymers to protein, preferably about 5% dry weight, is added. Representative hydrophilic polymers include maple fiber NOURAVANT^{®} (RENMATRIX^{®}) as described in the examples below, oat fiber, psyllium fiber, sodium alginate, pectin, methyl or carboxymethyl cellulose, maltodextrin. In most cases these have been processed to minimize texture and to have little to no flavor.

### III. Low Moisture Extruded Processing

### Blending of Ingredients

Ingredients are mixed, then fed into the extruder.

### Extrusion

A standard extruder is used under low moisture conditions.

According to the different water content of the final product, it can be divided into the following two categories:

### Low-Moisture Extrusion Process

The low-moisture extrusion process refers to the low-moisture fibrous protein products using plant meal or powders as the main raw materials, by pre-mixing different types of vegetable protein powders, then extruding, slicing, and drying to form a stable structured product. The fibrous protein products are sold or stored as prefabricated raw materials for meat products. Through extrusion technology,

### High-Moisture Extrusion Process

The moisture content of high-moisture extruded protein products is as high as 60-70%. The double-screw extrusion process is used to reorganize and align the protein to form a fibrous shape to obtain a stable structure, shape, color and texture can be used to simulate real meats, such as chicken, beef, pork or fish. Because of its high moisture content, it is not conducive to storage and requires refrigeration or frozen storage.

The pre-mixed ingredients are in accordance with the customized mature formula. Water and other additives are mixed during the extrusion process. The fiber structure is created during the extrusion process and the required fiber texture structure is stabilized. After the structure is stable, it can cooperate with the conveying and cutting equipment for deep processing of the product form.

A twin screw extruder is preferred. The extrusion is performed at between 130 and 165° C., preferably between 155-162° C.

Typical time of extrusion is 5-7 minutes, using an extruder with 62 mm diameter; 1240 mm long screws.

### MSDF Sanitary Mixer:

In the preferred embodiment, BCTG Polytwin™ twin-screw extruder, 62 mm diameter, 20:1 L/d (5 barrels), rotary cutter with flex blades. 224 kW (300 hp) drive a maximum screw speed of 1000 RpM, is used, with a High Sanitary Single-pass Dryer, 2 heating zones and 1 cooling zone, Brabender Volumetric Feeder, PRIOTHERM ® Conditioner and liquid addition cart with Netzsch progressive cavity pump and Endress-Houser flow meter are used.

Product is preferably extruded with a slotted die to produce pieces between one and 10 square inches (2.54 cm to 25.4 cm) length, height and/or width, although products can be produced in a range of sizes and shapes, varying from a 0.5 inch (1.27 cm) cube to much larger sizes of 8 inches (20.32 cm) by 7 inches (17.78 cm) by 1 inch (2.54 inches) pieces.

Either a dry extrusion or wet extrusion process can be used. The final product is dry, since the water and protein are mixed together in extruder, so that any moisture not bound by the protein flashes off as steam when it leaves the extruder.

### Post Extrusion Processing

The final product may be post processed, for example, breaded or coated, minced, mixed with sauce, packaged dry or frozen. The product can be utilized from pizza and salads meat crunch substitutes, nuggets, strips, schnitzel, fish sticks, seafood bites and rings all six breaded or not, meat in sauces (stew size to large steaks) grounded or minces patties.

The final product may be marketed as a beef, pork, chicken or seafood or fish product.

The product can be sold dry for further rehydration before usage, frozen wet, or used directly from wet extrusion production line.

### IV. Examples

The present invention will be further understood by reference to the following non-limiting examples.

### Example 1: Optimization of Pea Protein in Combination With Hydrophilic Polymers for Extrusion of Large Pieces.

### Materials and Methods

Studies were conducted to compare the extrudate products derived from several pea protein sources for the selection of a candidate that allowed the production of large plant-based meat pieces. PURIS® Pea 870 (Non-GMO Pea Protein) was used as the base.

Several extrusion runs were conducted in a Buhler 62 mm twin screw extruder using the following materials and methods:

### Screw Extruder

The screw extruder used in the examples has the die configurations listed in Table 1.

TABLE 1

Die Configurations

| | | |
|---|---|---|
| Transition Plate | BCTG-80229-810 02 | Revolver Plate w/ 1 ring |
| Cone + Spacers | BCTG-11213-010 | Flat cone w/ 2 spacers |
| Insert Plate | BCTG-11811-010 | |
| Inserts | 2- 14 mm x 1.6 mm slot x 3 mm Land | 23 mm dia. Brass button Inserts |
| Plugs | 6 - 23 mm plugs | |

### MSDF Sanitary Mixer:

BCTG Polytwin™ twin-screw extruder, 62 mm diameter, 20:1 L/d (5 barrels), rotary cutter with flex blades. 224 kW (300 hp) drive a maximum screw speed of 1000 RpM.
High Sanitary Single-pass Dryer, 2 heating zones and 1 cooling zone
Brabender Volumetric Feeder
PrioTherm ® Conditioner
Liquid Addition cart with Netzsch progressive cavity pump and Endress-Houser flow meter

Table 2 lists the parameters used for the extrusion process during the trial runs. These parameters of the extruder conditions (flow, temperature, pressure, dosages, RPM, etc) are the 10:40, 11:01, and 12:10. The optimal parameters for the extrusion process are listed in final column (12:10 parameters). These are hours and minutes, used to refer to specific extruder configurations and settings (flow, temperature, pressure, various dosages, RPM) .

TABLE 2

Process parameters for extrusion process

| Description | Unit | Mar. 2, 2022 10:40 | Mar. 2, 2022 11:01 | 3/3/22 12:10 |
|---|---|---|---|---|
| | | 0% h20 ext | Sample 1 | Optimal Parameters for lot #210520TL2 |
| | | Value | Value | Value |
| Basic quantity | kg% | 202.2 | 197.4 | 200 |
| Speed / Main drive | rpm | | | |
| Torque percent / Main drive | % | | | |
| Torque absolute / Main drive | Nm | | | |
| Power /Main drive | kW | | | |
| Throughput / Extruder | kg/h | | | |
| SME /Extruder | Wh/kg | | | |
| Speed / Cutter | rpm | 1202 | 1301 | 1552 |
| Torque / Cutter | % | 5 | 7 | 6 |
| Calcium Hydroxide | kg/h | 2 | 2 | 2 |
| Water to PrioTherm | kg/h | 11.2 | 8 | 4 |
| Water to Extruder | kg/h | 3.4 | 0 | 0 |
| Maple Fiber | kg/h | 49.6 | 49.5 | 47.8 |
| Brabender Feed system | kg/h | 202.2 | 197.4 | 200 |
| Heating/Cooling Barrels 3-4 | °C | 120 | 119 | 119 |
| Healing/Cooling Barrels 5-6 | °C | 130 | 130 | 130 |
| Heating/Cooling Barrels 7-8 | °C | 139 | 138 | 139 |
| Tempering Preconditioner Water | °C | 25 | 25 | 25 |
| Extruder Water Tempering | °C | 25 | 25 | 25 |
| Pressure / Endplate | bar | 30.6 | 28.1 | 28.3 |
| Temperature / Endplate | °C | 163 | 172 | 170 |
| Temperature Barrel 4 | C | 113 | 127 | 131 |
| Temperature Barrel 6 | C | 132 | 150 | 152 |
| Temperature Barrel 8 | C | 169 | 175 | 179 |
| Brabender Feed system | kg | 25.78 | 23.46 | 25.27 |

A summary of the samples and the ingredient composition of the resulting pea protein extrudates are provided in Table 3.

TABLE 3

Sample number and ingredient composition of the pea protein extrudates

| Sample Information | | | Functionality | | | | | Ions | | | | |
|---|---|---|---|---|---|---|---|---|---|---|---|---|
| | | | Gelation | | Water Binding Capacity (g water/g sample) | Viscosity (cP) | | | | | | |
| Sample | ID | Starting pH at 12% in solution | Gel Strength (g force) | Water Holding Capacity (%) | | Non-Heated | Heated | Phosphorus | Potassium | Sodium | Zinc | Calcium |
| #1 | 220215TL2 | 7.5 | 0 | 0 | 3.5 | 1125.4 | 651.6 | 1.24 | 0.231 | 0.956 | 140 | 0.402 |
| #2 | 210520TL2 | 7.48 | 0 | 39.1 | 2.23 | 440.8 | 290.3 | 1.41 | 0.247 | 0.106 | 116 | 0.713 |
| #3 | 210917TL2 | 7.53 | 0 | 33.2 | 2.29 | 417.9 | 490.6 | 1.36 | 1.7 | 0.017 | 126 | 0.591 |
| #4 | Green Boys | 7.12 | 0 | 0 | 3.67 | 1342.6 | 998.4 | 0.917 | 0.021 | 0.096 | 59 | 0.012 |
| #5 | Ripple Foods | 5.57 | 0 | 29.8 | 1.74 | 45.8 | 86.6 | 1.16 | 0.321 | 0.1 | 95 | 0.312 |
| #6 | Roquette Nutrylis F85 | 7.32 | 0 | 0 | 3.43 | 936.5 | 614.3 | 0.944 | 0.332 | 1.04 | 78 | 0.09 |
| #7 | 210616TL2 | 7.47 | 0 | 39 | 2.47 | 436.2 | 474.5 | 1.32 | 0.806 | 0.266 | 142 | 0.702 |

### Results

The specific characteristics of pea protein can cause the resulting extrudate to be hard and almost impossible to extrude. The methods and extrusion settings described above were applied to pea protein ingredients from several sources. Of the batches tested Sample 2 (Batch #210520TL2) resulted in the highest quality pea protein extrudate compared to Sample 1 (Batches 220215TL2) and Sample 3 (Batches 210917TL2) (Table 3). Sample 2 (Batch #210520TL2) was relatively easy to extrude and produced a smooth plant-based whole cut of meat. The nuggets produced from Sample 2 were relatively dry and had a width of about 1.5 inches. The optimal process conditions for Sample 2 (Table 2; final column) were applied to Sample 3 and the pea protein extrudate from both samples were visually compared. The extrudates from Sample 3 contained a 9% water content and did not have the smooth texture and nugget appearance as Sample 2.

Only proteins that have optimized water holding and binding capacity together with a low potassium content and high sodium content extrude smoothly to create consistent, well formed and meat like whole cuts of plant based protein. The extruded products of proteins outside of these specifications demand a much higher temperature, pressure and pH modification to denature and hydrate the pea protein. However, these products are very unfavorable in appearance and density. These flaws make it difficult to extrude pieces suitable to mimic whole meat cuts.

The tests conducted on the pea protein extrudate revealed several characteristics necessary for optimal extrusion of the pea protein. These characteristics are:
1) a water holding capacity above 35%,
2) water binding capability of above 2.5 g of water/g of sample,
3) viscosity of between about 400 centipoises (cp) to about 500 cp in the non-heated product, and
4) low buffer capacity which is driven by a high sodium content and low potassium content.

The tests confirmed that specific parameters for water holding capacity, water binding capability, viscosity, and a low buffer capacity (low potassium, high sodium) are necessary for extrusion of a cohesive meaty whole cut of plant-based meat from pea protein.

We claim:

1. Pea protein powder with improved processibility by low moisture extrusion and consistency of protein comprising
a water holding capability above 35% by weight,
a water binding capability above 2.5 g of water g,
a pea protein viscosity development between about 400 and 500 cp non-heated,
a potassium content below 0.2 % by weight, and
a sodium content above 0.8% by weight.
